(19) United States
(12) Patent Application Publication
(10) Pub. No.: US 2010/0021276 A1
(43) Pub. Date: Jan. 28, 2010

(54) Tilt loading platform for wheeled vehicles

(76) Inventor: James Baughman, Deford, MI (US)

Correspondence Address: JOHN R. BENEFIEL, 525 Lewis Street, BIRMINGHAM, MI, 48009, US

(21) Appl. No.: 12/220,442

(22) Filed: Jul. 24, 2008

(51) Int. Cl. B60P 1/04

(52) U.S. Cl. 414/484

(57) ABSTRACT

A tilting platform includes lengthwise extending beams with oppositely sloping bottom surfaces extending in from either end. A wheel supporting dolly assembly has inclined pieces on which forward beam bottom surfaces rest. A drive system shifts the dolly assembly forward from an intermediate position along the platform to allow the rear end of the platform to swing down and swings the platform back up when the dolly assembly is shifted back to the intermediate position to level the platform after loading.

### BACKGROUND OF THE INVENTION

This invention concerns wheeled cargo vehicles, i.e., trailers or trucks having load platforms adapted to be tilted in order to load an automobile or other equipment.

Tilt loading platforms allow a vehicle to be driven onto the platform. Such designs have typically involved complex arrangements and/or relatively uncontrolled tilting motion which may impose shocks on the automobile or other equipment carried by the truck.

In some of these designs, often referred to as “Texasrollback” trailers, inconvenient maneuvering of the towing vehicle is required during loading making the loading process slow and inconvenient.

Many of these tilting platform designs involve a relatively steep angle of tilt which can cause damage to the front facia when a low ground clearance vehicle is attempted to be driven up the inclined platform.

It is the object of the present invention to provide a tilting platform of the type described which is able to provide controlled tilting motion and is simple and convenient, and also provides a shallow platform angle to be particularly adapted to loading of low ground clearance vehicles.

It is a further object to provide such a tilting platform which does not require any maneuvering of a towing vehicle when loading a vehicle onto the platform and is otherwise simple to operate.

### SUMMARY OF THE INVENTION

The above recited objects and other objects which will become apparent upon a reading of the following specification and claims are achieved by a loading platform supported by one of more sets of wheels framed with side beams which have shallowly sloping bottom surfaces inclined downwardly from either end to a point intermediate their length. A dolly mounting two or more pairs of wheels includes a dolly frame which is mounted to the wheels which is inclined in a similar way to the sloping surfaces of the platform beams and is disposed beneath the forward sloping bottom surface of the beams which rests thereon.

The dolly frame and platform are driven by a drive system which interconnects the platform frame and dolly frame. The drive system may comprise a pair of longitudinally extending double acting power cylinders which when operated shift the dolly relative the platform forwardly toward the front end of the platform and retract the same back to the loaded position. The front end of the platform is held at a fixed height by a trailer hitch coupled to a towing vehicle (or by structure of a truck mounting the platform) during loading.

The shifting of the dolly assembly forwardly causes the rear end of the platform to be lowered in a controlled fashion as the dolly is shifted to the front and the sloping bottoms of the side beams at the rear move into a horizontal orientation and contact the ground or pavement when the platform is fully tilted down.

The resulting shallow angle of the platform allows low ground clearance vehicles to be driven up the tilted platform without danger of damaging the vehicle.

The dolly frame mounts upwardly projecting fenders for the wheels which shift forwardly out of alignment with the loaded vehicle doors when the platform is in the tilted loading position, allowing easy exit from the vehicle after driving the same onto the platform.

The power cylinders or other drive system is then operated to retract the dolly back to the middle area of the platform, causing the angled dolly frame to slide along the sloping bottom of the platform frame beams, facing the rear end of platform back up to a level orientation, when the dolly reaches its normal loaded position.

The drive system can alternatively be comprised of other means such as an electric motor winch system which pulls the dolly in either direction using cables wound up or paid out to shift the dolly along the platform side beams in either direction.

### DESCRIPTION OF THE DRAWINGS

FIG. 1 is a simplified side elevational view of a trailer incorporating a tilt platform according to the present invention, shown in the towing position and having a vehicle loaded thereon depicted in phantom lines, and showing a fragmentary portion of a connection to a towing vehicle.

FIG. 2 is a simplified side elevational view of the trailer shown in FIG. 1 with the platform in the tilted loading position.

FIG. 3 is a cross sectional view taken across the width of the trailer shown in FIGS. 1 and 2 looking forward from the rear.

FIG. 4 is an enlarged side view of the dolly with fragmentary portions of the platform.

FIG. 5 is a fragmentary pictorial view looking up at the underside of one side of the platform shown in FIGS. 1 and 2.

FIG. 6 is a fragmentary side view of a loaded tilting platform trailer incorporating a winch dolly cable dolly drive system.

FIG. 7 is a side view of the trailer shown in FIG. 6 with the platform in the tilted loading and unloading position.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

Referring to the drawings, a trailer 10 having a tilt platform according to the invention is, shown without some details such as lights, trim, etc, and includes a platform assembly 12 and a dolly assembly 14 which are relatively movable lengthwise with respect to each other.

The platform 12 includes a frame having two side beams 16 each having oppositely sloping bottom surface segments 18, 20.

The oppositely sloping bottom surfaces 18, 20 extend downwardly from each respective beam end and meet at a location intermediate the length of the trailer 10.

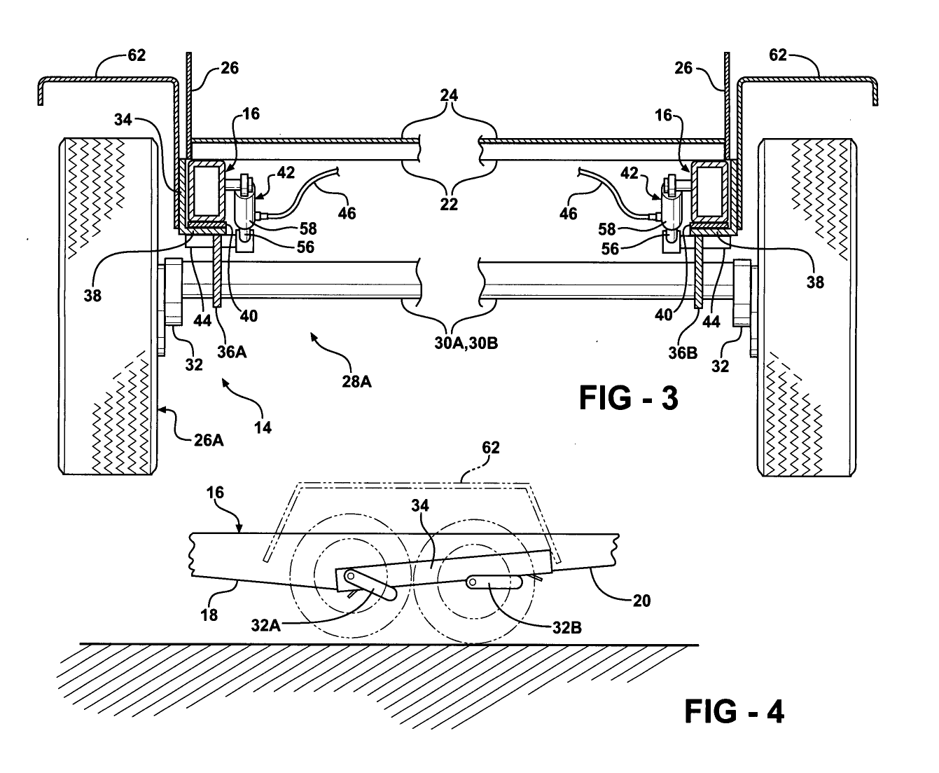

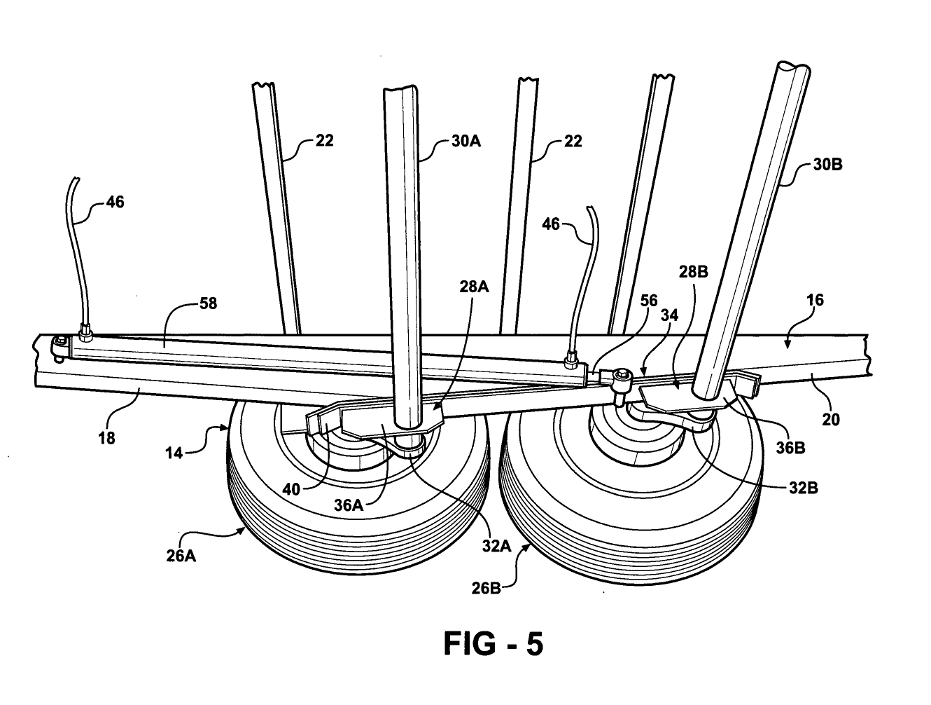

Cross tube members 22 are welded to the side beams 16 and a platform covering plate 24 is welded overlying the cross tubes 22 form the load supporting surface (FIG. 3). A carpet or other surfacing may cover the platform plate 24

Side pieces 26 are attached to the ends of the tubes 22 and deck covering plate 24 providing a confined area and complete the platform 12.

The dolly assembly 14 supports the platform 12, and includes one (or more) sets of conventional wheel-axle assemblies 26A, 26B which include axles, bearings, brakes, etc., disposed on either end of respective conventional torsion bar assemblies 28A, 28B.

The torsion bar assemblies 28A, 28B each include torsion bar square tube housings 20 which each support a swing arm 32 at each end connected to a wheel assembly 26A, 26B at one end. The swing arms 32 are attached to internal components which generate a spring force by compression of rubber elements within housings 30 in the well known manner. Such torsion bar/axle assemblies are well known and readily commercially available and thus will not be described in any further detail.

Such torsion bar assemblies 28A, 28B are available in various arm start angles. Here, the arm of the rearmost torsion bar assembly 28A is set at a steeper start angle than the forward torsion bar assembly 28B in order to incline a set of angle pieces 34 connected to the ends of the cross tubes 30A, 30B by weld brackets 36A, 36B (FIG. 3)

The cross tubes 30A, 30B and angles 34 together comprise a dolly frame to which the wheel/axle assemblies 26A, 26B are mounted.

This difference in start angles inclines the angle pieces 34 at an angle matched to the slope of the bottom wall 20. The horizontal web 38 of each of the angle pieces 34 receives the beam bottom surface 20 with an intermediate plastic bearing strip 40 provided to reduce friction and wear from sliding contact.

The dolly assembly 14 is normally generally positioned just forward of the point where the two sloping surfaces 18, 20 meet, the angle pieces 34 occupying the lowest segment of the forward sloping bottom surface 20 of each side beam 16.

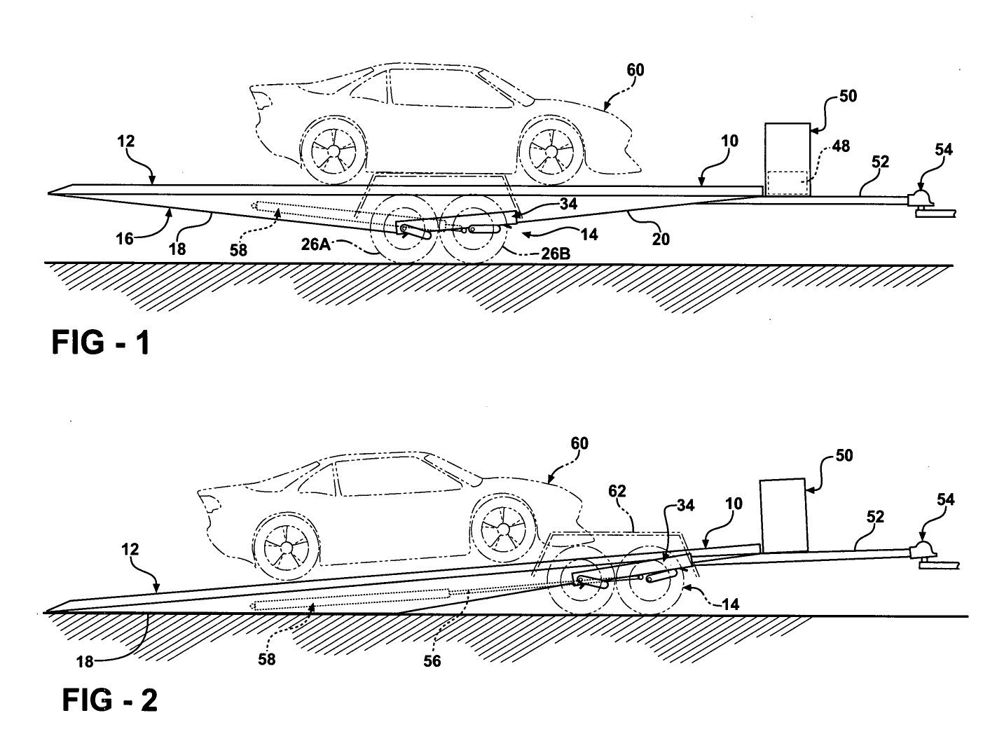

The trailer is balanced in this position ready for towing as seen in FIG. 1.

The dolly assembly 14 is held in this position by a dolly drive system here comprised of a pair of double acting power cylinders 42, each having a cylinder end pinned to a respective beam 16 and a rod end pinned to a respective angle piece 34 by an anchor pin 44 welded thereto.

Hydraulic lines 46 for each cylinder extend to a battery powered hydraulic pressure source 48 carried in a housing 50 on a triangular platform extension 52 at the forward end of the trailer 10.

A coupling 54 for connection to a towing vehicle (not shown) is attached at the front end of the extension 52.

For loading and unloading, the power cylinders 44 are pressurized to extend the rods 56 out of the cylinders 58, moving the dolly assembly 14 forward relative the platform 12. The dolly frame angle pieces 34 engage successive segments of the bottom surfaces 20 as the platform 12 swings down about the fixed pivot point defined by the coupling 54 which must be held during this process.

That is, the trailer 10 must be coupled to a towing vehicle (not shown) in order to load and unload since the trailer forward end must be held fixed in order that only the rear end moves down and up as the dolly assembly 14 is shifted forward and back.

As the rear of the platform 12 slowly swings down, the rear sloping beam bottom surfaces 18 move into a horizontal orientation and engages the pavement or ground as seen in FIG. 2.

The angle of slope of the bottom surfaces 18, 20 is quite shallow so that a shallow loading angle is presented, i.e., a one in twelve pitch (or 4-7°) is satisfactory so that low ground clearance vehicles can be easily driven up the platform 12.

After the vehicle 60 to be loaded has been driven onto the platform 12 as shown in FIG. 2, the power cylinders 44 are again operated but in a reverse direction to retract the rods 56 and draw the dolly assembly 14 rearward, the engagement of the angle pieces 34 with beam sloping bottom surfaces 20 forcing the rear of the trailer 10 up to again assume the towing position of FIG. 1.

It should be noted that no movement of the trailer 10 is involved in loading, other than the gradual, controlled tilting of the platform 12, and the tilting is at a controlled speed at all times, such that shocks to the vehicle 60 during loading are completely avoided.

Fenders 62 are provided for the wheels 26, which are moved forwardly when loading, so that they are clear of the doors of the vehicle 60, allowing the driver to easily exit the vehicle 60 after loading.

The invention is simple yet provides a controlled gentle tilting motion and a low angle loading platform for maximum protection of the vehicle.

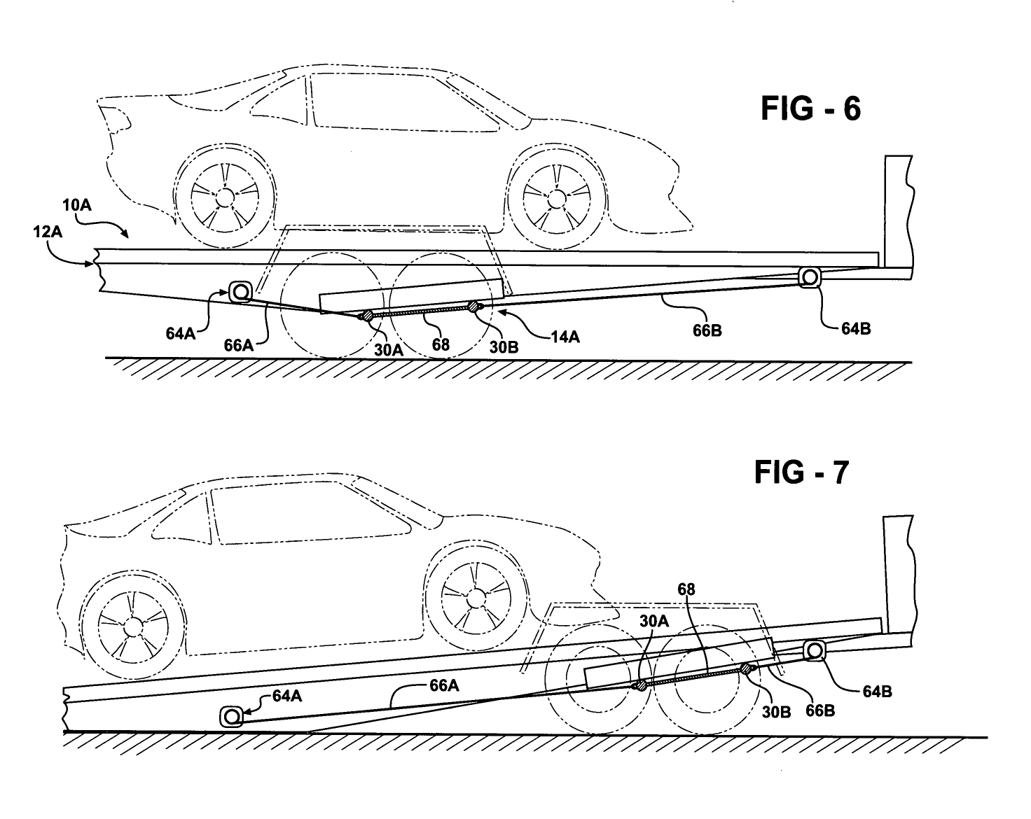

FIGS. 6 and 7 show a tilting trailer 10A incorporating an alternate form of dolly drive system comprised of a pair of electric motor driven cable winches 64A, 64B located on the platform frame to the rear and forwardly of the dolly assembly 14A.

A cable 66A extends from the rear motor-winch 64A to the center of the rear cross tube 30A forming a part of the dolly frame.

A cable 66B extends from the forward motor-winch 64B to the center of the cross tube 30B.

A stiffener plate 68 may be welded between the tubes 30A, 30B to strengthen the dolly frame as necessary to withstand the pulling force exerted by cable 66A, 66B.

When energized, the forward motor-winch 64B pulls the dolly assembly 14A forward in order to cause the platform 12A to swing down for loading as seen in FIG. 7. The cable 66A of the rear winch 64A is controllably paid out to allow this.

The rear winch 64A is operated to pull the dolly assembly 14A back to the position seen in FIG. 6 for towing. Cable 66B is paid out to allow this motion.

Other dolly drive systems involving screw shafts, gearing, etc. may also be employed. While the tilting platform is shown incorporated into a trailer, it can also be adapted to a truck body by movably mounting a set of rear wheels partially supporting the tilting platform (which could be enclosed). In this case the rear wheels can not be driven, and the brakes must be mountable relative to the truck body.

1. A tilting platform for supporting a wheeled vehicle comprising:
a platform including platform frame including a pair of lengthwise extending beams located below said platform, each beam having oppositely angled bottom surfaces extending downwardly from a forward end and a rear end and meeting at an intermediate location along the length of said platform frame;
said platform having a trailer coupling mounted to said forward end;
a dolly assembly supporting one or more sets of wheels, said dolly assembly including an inclined dolly frame mounted to said one or more sets of wheels extending at an angle to be inclined in the same direction and inclination as said surfaces of said beam bottoms extending from the forward end of said platform when said platform is not tilted, said beam bottom surfaces extending from said forward end engaging said inclined dolly frame in both level and tilted conditions of said platform frame;
said dolly assembly normally disposed at a position just forward of said intermediate location along said platform with said platform frame held in a level loaded position by said dolly frame;
said dolly frame shifted from said position just forward of said intermediate location by a dolly drive in a direction towards said forward end of said platform in engagement with said sloping bottom surface of each of said beams extending from said forward end of said platform with said coupling attached to a towing vehicle, said platform swung down about said forward end as said dolly assembly is shifted forwardly until said beam bottom surfaces extending from said rear end of said platform come to rest on a supporting surface with said platform frame inclined at a tilted an angle; said dolly drive also operable to shift said dolly assembly back to said position just forward of said intermediate location, said platform frame thereby swung back up to a level loaded position by interengagement of said inclined dolly frame and said beam angled bottom surfaces at the forward end of each of said bottom beams.

2. The tilting platform according to claim 1 wherein said dolly drive comprises a pair of double acting power cylinders extending lengthwise beneath said platform, each cylinder connected at one end to said platform frame and at the other end to said dolly frame so that when extended said dolly assembly is shifted towards said forward end of said platform and when shifted back to said intermediate position.

3. The tilting platform according to claim 1 wherein said wheels in each set are connected by cross members forming a part of said dolly frame together with inclined pieces extending lengthwise and connected to incline said dolly frame.

4. The tilting platform according to claim 3 wherein said cross members comprise torsion bar housings, and further include torsion bar arms mounted at each end of each cross member and to a wheel hub of a respective wheel in said wheel sets.

5. The tilting platform according to claim 1 wherein said dolly drive arrangement comprises a pair of electric motors each mounted respectively to said platform forward and rearward of said dolly assembly, a respective winch driven by a respective electric motor, each cable extending from an associated winch to a forward and rear end of said dolly frame respectively, said electric motors alternatively driving said dolly assembly forwardly and rearwardly when activated.

6. A tilting platform according to claim 1 wherein said dolly frame has opposite sides and a wheel fender is mounted on each side opposite enclosing upper parts of said wheels, said fenders moving forward with movement of said dolly frame.

7. A tilting platform according to claim 2 wherein said power cylinders are hydraulic and further including a battery powered hydraulic pressure source mounted on said platform.

8. A tilting platform according to claim 1 wherein said tilted angle is on the order of 4 to 5 degrees.

9. The tilting platform according to claim 1 wherein said wheels in each set are connected by cross members forming a part of said dolly frame with inclined pieces extending lengthwise and connected between each wheel set and wherein said dolly frame inclined pieces each have a horizontally extending portion supporting a respective one of said beam bottom surfaces extended down from said forward end and a vertically extending portion extending alongside said a respective beam.

10. A tilting platform according to claim 1 wherein said platform has an extension section projecting towards said forward end of said platform, and said trailer coupling is mounted at a forward end of said extension for attachment to a towing vehicle.
